(19) United States
(12) Patent Application Publication
(10) Pub. No.: US 2026/0099689 A1
(43) Pub. Date: Apr. 9, 2026

(54) TAPE PRINTING DEVICE, PRINTING METHOD, AND NON-TRANSITORY COMPUTER-READABLE STORAGE MEDIUM STORING PROGRAM

(71) Applicant: Seiko Epson Corporation, Tokyo (JP)

(72) Inventor: Hideyuki TSUKUDA, Matsumoto-shi (JP)

(73) Assignee: Seiko Epson Corporation, Tokyo (JP)

(21) Appl. No.: 19/348,255

(22) Filed: Oct. 2, 2025

(30) Foreign Application Priority Data
Oct. 3, 2024 (JP) 2024-173972

(51) Int. Cl. G06K 15/02; B41J 2/325; B41J 3/407; B41J 3/46; B41J 11/70; B41J 15/04; G06K 15/00

(52) U.S. Cl. CPC G06K 15/1842; B41J 3/4075; B41J 3/46; G06K 15/005; G06K 15/028; G06K 15/1831; G06K 15/1856; B41J 2/325; B41J 11/703; B41J 15/044; G06K 2215/0037; G06K 2215/0057

(57) ABSTRACT

A tape printing device that executes printing on a tape-like printing medium includes an input portion that receives input of a character string and designation of a printing condition, a controller, a storage portion storing at least one definition table that is used when particular printing is executed in which sizes of respective characters included in the character string are stepwise changed to print the character string and that defines the sizes of the respective characters included in the character string in correspondence with the number of characters in the character string and a width of the printing medium, and a printing portion. The controller, when the printing condition designates the particular printing, sets the sizes for the respective characters included in the character string based on the definition table, and generates specific print data indicating that each character is to be printed in the size set for the character.

The present application is based on, and claims priority from JP Application Serial Number 2024-173972, filed Oct. 3, 2024, the disclosure of which is hereby incorporated by reference herein in its entirety.

### BACKGROUND

### 1. Technical Field

The present disclosure relates to a tape printing device, a printing method, and a non-transitory computer-readable storage medium storing a program.

### 2. Related Art

There is a demand to print a character string having a sense of perspective. In the technology described in JP-A-7-64983, a character string having a sense of perspective is printed in a proportionally spaced state, that is, in a state in which character spacing corresponding to a character width is performed, with respect to characters of a proportional font in which the character width differs for each character. In the technology described in JP-A-7-64983, a process is performed in which (i) an intermediary variable representing a delimiting position of each character with respect to the entire character string is obtained, (ii) character frame coordinates of each character are determined by substituting the intermediary variable into a character string layout function for each character, and (iii) for each character, a coordinate system of a character frame is converted into a coordinate system corresponding to a font body size by setting a new coordinate system through changing an origin of the coordinates according to the character width.

In the technology described in JP-A-7-64983, many processes are required to print a character string having a sense of perspective. Therefore, there is room for further improvement in an aspect of printing a character string having a sense of perspective.

### SUMMARY

The present disclosure can be implemented in the following aspects.

According to a first aspect of the present disclosure, there is provided a tape printing device that performs printing on a tape-like printing medium. The tape printing device includes an input portion that receives input of a character string and designation of a printing condition, a controller that controls the tape printing device, a storage portion that stores at least one definition table used when particular printing is executed in which sizes of respective characters included in the character string are stepwise changed to print the character string, the definition table defining the sizes of the respective characters included in the character string in correspondence with the number of characters in the character string and a width of the printing medium, and a printing portion that prints the input character string on the printing medium. The controller, when the printing condition designates the particular printing, sets the size for each character included in the character string based on the definition table corresponding to the number of characters and the width, and generates specific print data indicating that each character is to be printed in the size set for the character. The printing portion prints the character string on the printing medium based on the specific print data.

According to a second aspect of the present disclosure, there is provided a printing method executed by a tape printing device that performs printing on a tape-like printing medium. The printing method includes receiving input of a character string and designation of a printing condition, executing printing on the printing medium, and when the designation of the printing condition designates particular printing in which sizes of respective characters included in the character string are stepwise changed to print the character string, setting the sizes for the respective characters included in the character string based on at least one definition table corresponding to the number of characters in the character string and a width of the printing medium, the definition table defining the sizes of the respective characters included in the character string, generating specific print data indicating that each character is to be printed in the size set for the character, and printing the character string on the printing medium based on the specific print data.

According to a third aspect of the present disclosure, there is provided a non-transitory computer-readable storage medium storing a program for causing a tape printing device that performs printing on a tape-like printing medium to execute printing. The program causes the tape printing device to implement a function of receiving input of a character string and designation of a printing condition, and a function of executing printing on the printing medium. The function of executing printing on the printing medium includes, when the designation of the printing condition designates particular printing in which sizes of respective characters included in the character string are stepwise changed to print the character string, a function of setting the sizes for the respective characters included in the character string based on at least one definition table corresponding to the number of characters in the character string and a width of the printing medium, the definition table defining the sizes of the respective characters included in the character string, a function of generating specific print data indicating that each character is to be printed in the size set for the character, and a function of printing the character string on the printing medium based on the specific print data.

### BRIEF DESCRIPTION OF THE DRAWINGS

FIG. 1 is a perspective view illustrating a tape printing device in the present embodiment.

FIG. 2 is a block diagram illustrating a configuration of each portion of the tape printing device.

FIG. 3 is an explanatory diagram illustrating an example of a print result.

FIG. 4 is an explanatory diagram illustrating another example of the print result.

FIG. 5 is an explanatory diagram illustrating an example of a definition table for a stepwise reduction mode.

FIG. 6 is an explanatory diagram illustrating an example of a definition table for a stepwise enlargement mode.

FIG. 7 is an explanatory diagram illustrating an example of another definition table for the stepwise enlargement mode.

FIG. 8 is an explanatory diagram illustrating an example of another definition table for the stepwise reduction mode.

FIG. 9A is a flowchart illustrating a printing process in the tape printing device.

FIG. 9B is an explanatory diagram illustrating an example of a selection screen.

FIG. 10 is an explanatory diagram illustrating an example of a definition table according to a second embodiment.

FIG. 11 is an explanatory diagram illustrating an example of a print result according to the second embodiment.

FIG. 12 is an explanatory diagram illustrating an example of a print result according to a third embodiment.

FIG. 13 is an explanatory diagram illustrating another example of the selection screen.

FIG. 14 is an explanatory diagram of a definition table used when printing is performed in a composite first mode.

### DESCRIPTION OF EMBODIMENTS

### A. First Embodiment

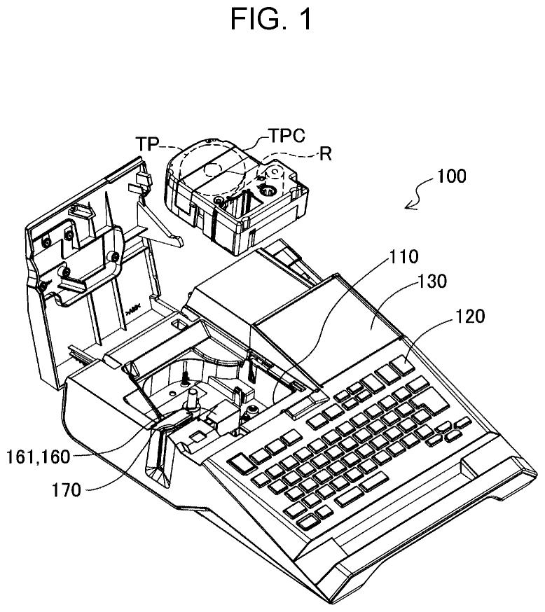

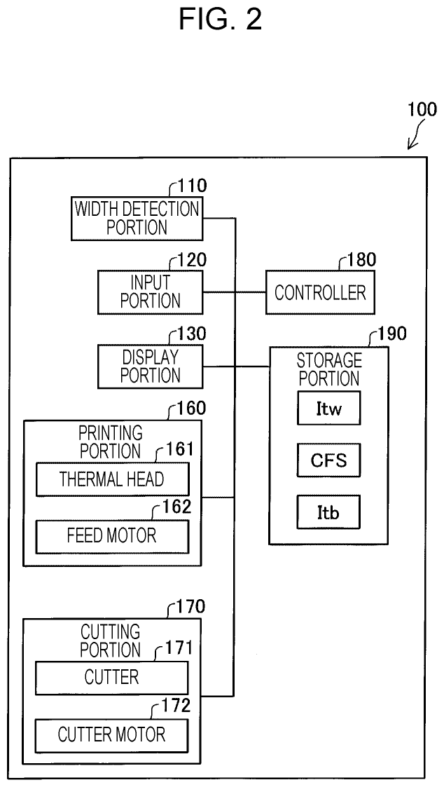

FIG. 1 is a perspective view illustrating a tape printing device 100 in the present embodiment. FIG. 2 is a block diagram illustrating a configuration of each portion of the tape printing device 100. The tape printing device 100 illustrated in FIG. 1 executes printing on a tape TP, which is a printing medium. The tape TP is attached to the tape printing device 100 in a state of being stored in a tape cartridge TPC. The tape cartridge TPC is replaceable. An ink ribbon R is stored in the tape cartridge TPC together with the tape TP. In the tape printing device 100, ink is thermally transferred from the ink ribbon R onto a surface of the tape TP, and characters, symbols, and the like are printed on the surface of the tape TP.

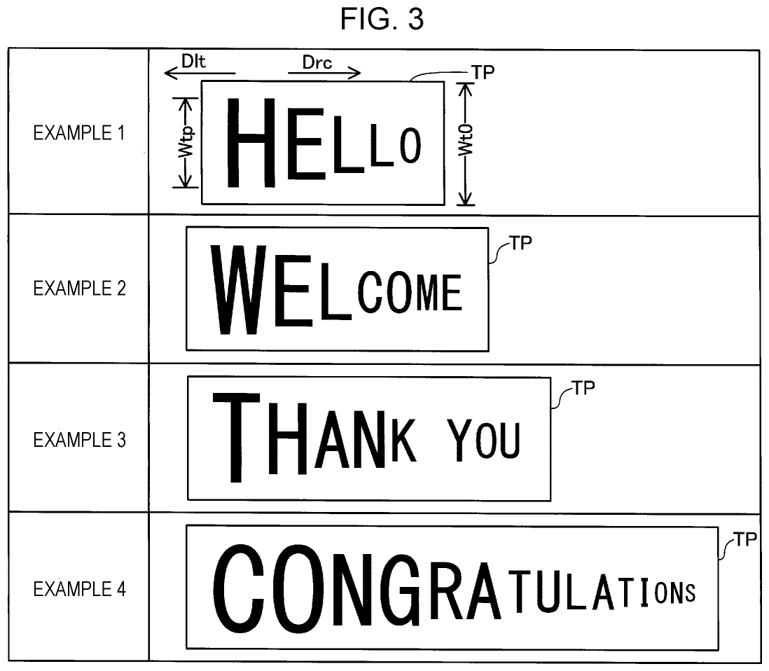

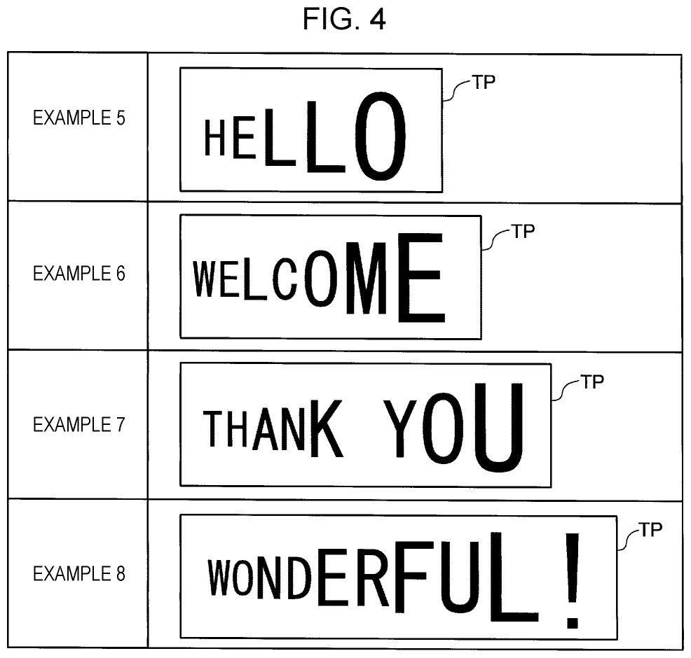

FIGS. 3 and 4 are explanatory diagrams illustrating examples of print results. The tape printing device 100 can execute horizontal printing and vertical printing, but in the present embodiment, an example of horizontal printing will be described. In horizontal printing, a character string is disposed such that a feed direction Dlt of the tape TP is parallel to a direction Drc in which characters are to be read. The direction Drc in which the characters are to be read is a direction intersecting a width direction of the tape TP, which is the printing medium. Here, printing is assumed to be performed using a language that corresponds to horizontal writing and in which characters are sequentially arranged from left to right. In FIG. 3, an arrow labeled Dlt indicates the feed direction Dlt of the tape TP during printing. An arrow labeled Drc indicates the direction Drc in which the characters are to be read. In the present specification, a character string is a set of characters, symbols, emojis, and the like that are disposed side by side in a direction to be read. The same applies to the other drawings. In the following description, characters, symbols, emojis, and the like that constitute the character string are collectively referred to as characters. The feed direction of the tape TP during printing is parallel to a longitudinal direction of the tape TP. In a label on which horizontal printing is performed, when a user visually recognizes a state in which the tape TP is disposed such that the longitudinal direction of the tape TP is positioned left to right, characters are printed in horizontal writing on the tape TP. In addition, in the present specification, it is assumed that a single line of a character string is printed on the tape TP, and an aspect in which two or more lines of character strings are printed is not considered.

In the present embodiment, the tape printing device 100 has a function of printing a character string in an aspect having a sense of perspective by executing printing while stepwise changing sizes of respective characters included in the character string. In the present specification, printing in which a character string is printed in an aspect having a sense of perspective by executing printing while stepwise changing the sizes of the respective characters included in the character string is referred to as “perspective transformation printing”. The perspective transformation printing is also referred to as “particular printing”.

In the examples illustrated in FIG. 3, the character string is printed in an aspect in which the sizes of the characters gradually decrease in the direction Drc in which the characters are to be read. Such a method of the perspective transformation printing is referred to as a “stepwise reduction mode”. In FIG. 3, the direction Drc is indicated only in Example 1, but in the other examples in FIG. 3 and in each example in FIG. 4, the direction Drc in which the characters are to be read is the same. The direction Drc in which the characters are to be read may be referred to as an arrangement direction of characters. In the examples illustrated in FIG. 3, a sense of depth is expressed such that the first character in the arrangement direction of characters is disposed at the foremost, and the last character in the arrangement direction of characters is disposed at the rearmost. Printing in the “stepwise reduction mode” is also referred to as “second perspective transformation printing”.

In the examples illustrated in FIG. 4, the character string is printed in an aspect in which the sizes of the characters gradually increase in the direction Drc in which the characters are to be read. Such a method of the perspective transformation printing is referred to as a “stepwise enlargement mode”. In the examples illustrated in FIG. 4, a sense of depth is expressed such that the first character in the arrangement direction of characters is disposed at the rearmost, and the last character in the arrangement direction of characters is disposed at the foremost. Printing in the “stepwise enlargement mode” is also referred to as “first perspective transformation printing”.

As illustrated in FIG. 2, the tape printing device 100 includes a width detection portion 110, an input portion 120, a display portion 130, a printing portion 160, a cutting portion 170, a controller 180, and a storage portion 190. In FIG. 1, the controller 180 and the storage portion 190 are not illustrated.

As illustrated in Example 1 of FIG. 3, the width detection portion 110 detects a tape width Wt0, which is a width of the tape TP attached to the tape printing device 100. Specifically, the width detection portion 110 is a sensor that detects the tape width Wt0 based on protrusions and recesses provided on an outer surface of the tape cartridge TPC attached to the tape printing device 100. The protrusions and recesses provided on the outer surface of the tape cartridge TPC indicate the tape width Wt0 of the tape TP stored in the tape cartridge TPC. The type of the tape cartridge TPC is determined according to the tape width Wt0. Tape cartridges TPC having tape widths Wt0 of 4 mm, 6 mm, 9 mm, 12 mm, 18 mm, 24 mm, and 36 mm can be attached to the tape printing device 100.

As illustrated in FIG. 1, the input portion 120 is a keyboard and receives input from the user. The display portion 130 is a monochrome liquid crystal display and displays characters and images in monochrome. The printing portion 160 illustrated in FIG. 2 executes printing on the attached tape TP. The printing portion 160 includes a thermal head 161 and a feed motor 162. The thermal head 161 includes a plurality of heat generating elements (not illustrated). The thermal head 161 thermally transfers ink from the ink ribbon R onto the surface of the tape TP to form a plurality of dots. The feed motor 162 feeds the tape TP and the ink ribbon R by being rotationally driven.

The cutting portion 170 cuts the tape TP on which printing is performed by the printing portion 160. The cutting portion 170 includes a cutter 171 that cuts the tape TP and a cutter motor 172 that drives the cutter 171. The tape TP cut by the cutter 171 is discharged from a tape discharge port of the tape printing device 100. One cut tape TP is used as a label.

The controller 180 is a processor that controls the tape printing device 100. The controller 180 implements various functions of the tape printing device 100 by executing a program stored in the storage portion 190.

The storage portion 190 stores information. The storage portion 190 includes a random access memory (RAM) and a read only memory (ROM). Various programs and parameters are stored in the storage portion 190. Additionally, the storage portion 190 stores a print width information set Itw, a character font data set CFS, and a character size definition table set Itb.

The print width information set Itw holds a print width Wtp in association with each of the tape widths Wt0 of the tape TP that can be attached to the tape printing device 100. As illustrated in Example 1 of FIG. 3, the print width Wtp is a dimension in the width direction of the tape TP with respect to a printable region on the tape TP.

The character font data set CFS includes data for designating a shape of each character used when the tape printing device 100 prints characters. The data for designating the shape of the character is a set of pieces of data indicating ON/OFF, each associated with one of a plurality of pixels arranged within a rectangular region in which a single character is to be recorded. Recording is performed on a pixel associated with ON. Recording is not performed on a pixel associated with OFF. The shape of the character is represented by a set of pixels on the tape TP on which recording is performed, that is, a set of dots.

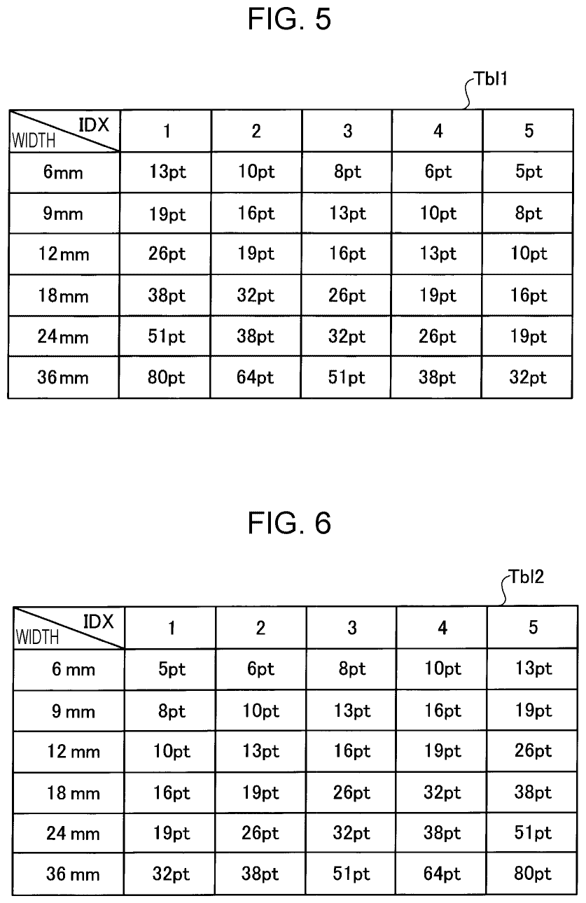

FIGS. 5 to 8 are explanatory diagrams illustrating examples of a definition table used for the perspective transformation printing. The character size definition table set Itb includes a plurality of definition tables. In each of the definition tables, the size of the character to be printed on the tape TP when the perspective transformation printing is executed is defined in correspondence with the tape width Wt0 of the tape TP, which is the printing medium. Each of the definition tables is associated with the number of characters to be printed. In the present embodiment, execution of perspective transformation printing is not assumed when the number of characters to be printed is less than three. This is because, when the number of characters is less than three, it is difficult to impart a sense of depth to the character string to be printed even in a case where the sizes of the characters are stepwise changed.

A definition table Tbl1 illustrated in FIG. 5 is used when a five-character character string is printed in the “stepwise reduction mode”. In the definition table Tbl1, the sizes of the characters to be printed on the tape TP during printing in the “stepwise reduction mode” are defined for each tape width Wt0 of the tape TP. In the definition table Tbl1, the tape width Wt0 of the tape TP is referred to as a “width”. Further, in the definition table Tbl1, a position at which a character is disposed within the character string to be printed, that is, the order of the character, is referred to as “IDX”. The same applies to other definition tables to be described below. In the definition table Tbl1, the sizes of the respective characters that constitute the character string are defined such that the sizes of the characters stepwise decrease in the arrangement direction of characters. Although the tape printing device 100 can perform printing on a tape TP having a tape width Wt0 of 4 mm, the tape TP having a tape width Wt0 of 4 mm is excluded from the definition table Tbl1 because it is difficult to express a sense of perspective even when perspective transformation printing is performed.

In the present embodiment, a maximum value of the sizes of the characters that correspond to the tape width Wt0 defined in the definition table Tbl1 is set to a maximum character size that can be printed on the tape TP having the tape width Wt0. For example, the maximum character size that can be printed on a tape TP having a tape width Wt0 of “36 mm”is “80 pt”.

For example, in the definition table Tbl1, when a character string including five characters is printed on the tape TP having a tape width Wt0 of “36 mm”, it is defined that the sizes of the respective characters are set as follows.
Size of the first character: 80 pt
Size of the second character: 64 pt
Size of the third character: 51 pt
Size of the fourth character: 38 pt
Size of the fifth character: 32 pt

By setting the sizes of the respective characters as described above and executing printing in the “stepwise reduction mode”, a print result illustrated in Example 1 of FIG. 3 is obtained.

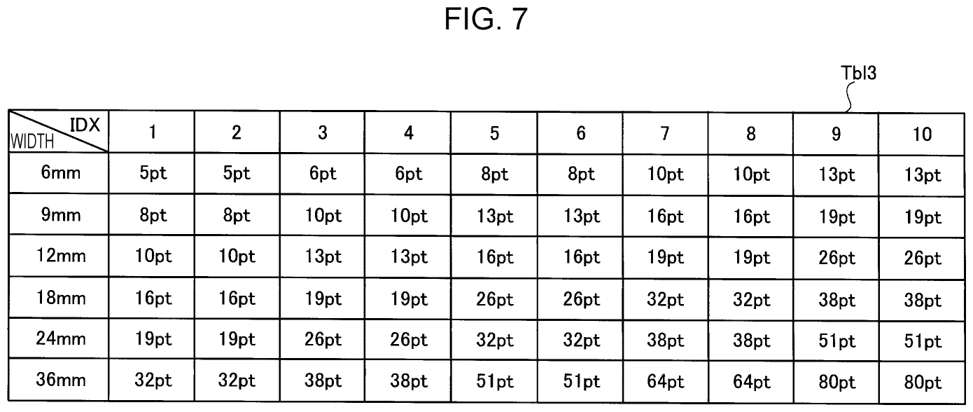

A definition table Tbl2 illustrated in FIG. 6 is used when a five-character character string is printed in the “stepwise enlargement mode”. In the definition table Tbl2, the sizes of the characters to be printed on the tape TP during printing in the “stepwise enlargement mode” are defined for each tape width Wt0 of the tape TP. In the definition table Tbl2, the sizes of the respective characters that constitute the character string are defined such that the sizes of the characters stepwise increase in the arrangement direction of characters. For example, in the definition table Tbl2, when a character string including five characters is printed on the tape TP having a tape width Wt0 of “36 mm”, it is defined that the sizes of the respective characters are set as follows.
Size of the first character: 32 pt
Size of the second character: 38 pt
Size of the third character: 51 pt
Size of the fourth character: 64 pt
Size of the fifth character: 80 pt

By setting the sizes of the respective characters as described above and executing printing in the “stepwise enlargement mode”, a print result illustrated in Example 5 of FIG. 4 is obtained.

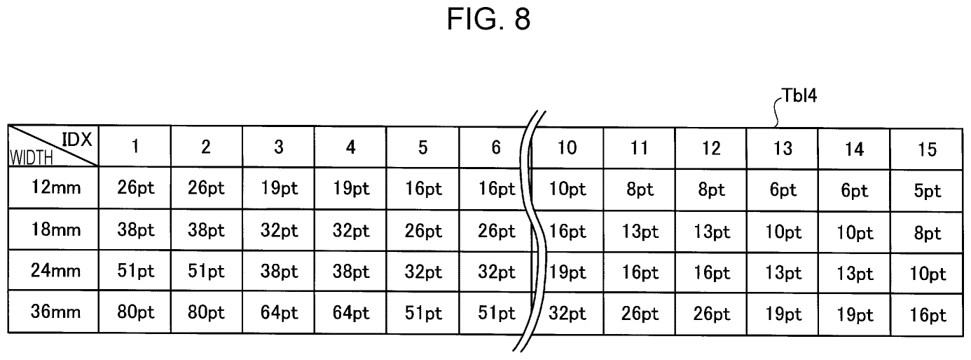

A definition table Tbl3 illustrated in FIG. 7 is used when a 10-character character string is printed in the “stepwise enlargement mode”. In the definition table Tbl3, the sizes of the characters to be printed on the tape TP during printing in the “stepwise enlargement mode” are defined for each tape width Wt0 of the tape TP. In the definition table Tbl3, the sizes of the respective characters that constitute the character string are defined such that the sizes of the characters stepwise increase in the arrangement direction of characters. In the definition table Tbl2, the sizes of two adjacent characters are set to be different, whereas in the definition table Tbl3, the sizes of two adjacent characters may be set to be the same. This is to make the stepwise change in character size more gradual and to prevent the vertical dimension of the smallest character to be printed from becoming extremely small relative to the tape width Wt0.

By setting the sizes of the respective characters using the definition table Tbl3 and executing printing in the “stepwise enlargement mode”, for example, a print result illustrated in Example 8 of FIG. 4 is obtained. The definition table used when a 10-character character string is printed in the “stepwise reduction mode” will not be illustrated.

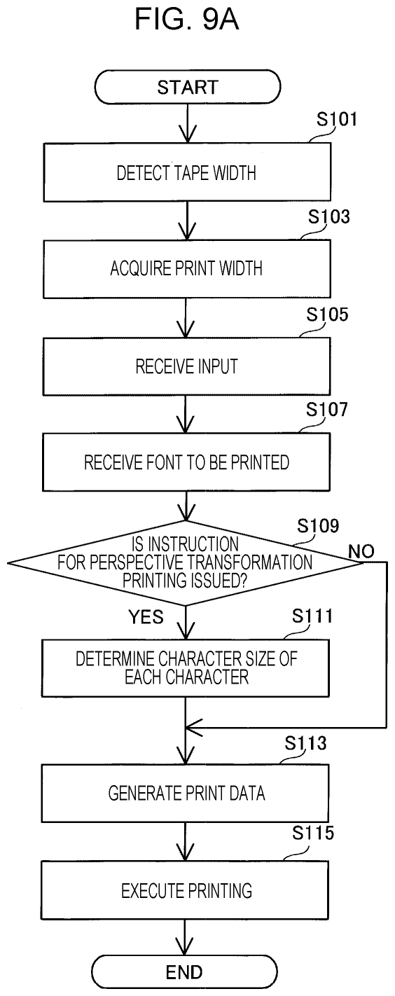

A definition table Tbl4 illustrated in FIG. 8 is used when a 15-character character string is printed in the “stepwise reduction mode”. In the definition table Tbl4, the sizes of the characters to be printed on the tape TP during printing in the “stepwise reduction mode” are defined for each tape width Wt0 of the tape TP. In the definition table Tbl4, the sizes of the respective characters that constitute the character string are defined such that the sizes of the characters stepwise decrease in the arrangement direction of characters. Similarly to the definition table Tbl3, in the definition table Tbl4, the sizes of two adjacent characters may be set to be the same. This is to make the stepwise change in character size more gradual and to prevent the vertical dimension of the smallest character to be printed from becoming extremely small relative to the tape width Wt0.

By setting the sizes of the respective characters using the definition table Tbl4 and executing printing in the “stepwise reduction mode”, for example, a print result illustrated in Example 4 of FIG. 3 is obtained. The definition table used when a 15-character character string is printed in the “stepwise enlargement mode” will not be illustrated.

Ideally, it is desirable to prepare definition tables corresponding to the number of characters in the character string to be printed, respectively. However, from the viewpoint of the effort required to create the definition tables and the capacity occupied by the definition tables in the storage portion 190, it is not practical to individually prepare definition tables according to the number of characters to be printed.

In the present embodiment, a single definition table may be shared when different numbers of characters are printed. A single definition table is shared when a difference between the number of characters to be printed and the number of characters that the definition table corresponds to falls within a certain range. In this case, the definition table is used even when the number of characters to be printed exceeds or falls short of the number of characters that the definition table corresponds to. Specifically, the definition table Tbl1 illustrated in FIG. 5 is used when a character string of four to eight characters is printed in the “stepwise reduction mode”. The definition table Tbl2 illustrated in FIG. 6 is used when a character string of four to eight characters is printed in the “stepwise enlargement mode”. The definition table Tbl3 illustrated in FIG. 7 is used when a character string of 9 to 13 characters is printed in the “stepwise enlargement mode”. When the character string of 9 to 13 characters is printed in the “stepwise reduction mode”, a definition table for 10 characters (not illustrated) for the stepwise reduction mode is used. The definition table Tbl4 illustrated in FIG. 8 is used when a character string of 14 to 18 characters is printed in the “stepwise reduction mode”. When a character string of 14 to 18 characters is printed in the “stepwise enlargement mode”, a definition table for 15 characters (not illustrated) for the stepwise enlargement mode is used.

Hereinafter, a method for sharing the definition table will be described. In Example 2 of FIG. 3, a seven-character character string is printed in the “stepwise reduction mode”. As mentioned above, when a character string of four to eight characters is printed in the “stepwise reduction mode”, the definition table Tbl1 illustrated in FIG. 5 is used. In this case, the number of characters to be printed is two more than the number of characters that the definition table Tbl1 corresponds to.

Therefore, Rule 1 is applied in which the size of some characters in the character string is set to the size of the character that is set for an adjacent character. A value obtained by doubling a difference D1 between the number of characters to be printed and the number of characters that the definition table Tbl1 corresponds to is referred to as an applicable character count N1. Characters to which Rule 1 is applied are the characters equal in number to the applicable character count N1, counted in a direction opposite to the arrangement direction of characters, starting from the last character of the character string. In Example 2 of FIG. 3, since the difference D1 between the number of characters to be printed and the number of characters that the definition table Tbl1 corresponds to is two, the applicable character count N1 is four. Accordingly, four characters, counted from the last character of the character string in a direction opposite to the arrangement direction of characters, are subject to the application of Rule 1.

The sizes of the fourth character and the fifth character in the character string to be printed are set to the size of the fourth character defined in the definition table Tbl1, that is, the size of the character at IDX “4”. The sizes of the sixth character and the seventh character in the character string to be printed are set to the size of the fifth character defined in the definition table Tbl1, that is, the size of the character at IDX “5”. The size of the character that corresponds to the tape width Wt0 is set. By setting the sizes of the respective characters in this manner and executing printing in the “stepwise reduction mode”, a print result illustrated in Example 2 of FIG. 3 is obtained.

In Example 3 of FIG. 3, eight characters are printed. Here, spaces are not included in the number of characters. The number of characters to be printed is three more than the number of characters that the definition table Tbl1 corresponds to. In Example 3 of FIG. 3, since the difference D1 between the number of characters to be printed and the number of characters that the definition table Tbl1 corresponds to is three, the applicable character count N1 is six. Accordingly, six characters, counted from the last character of the character string in a direction opposite to the arrangement direction of characters, are subject to the application of Rule 1.

The sizes of the third character and the fourth character in the character string to be printed are set to the size of the third character defined in the definition table Tbl1, that is, the size of the character at IDX “3”. The sizes of the fifth character and the sixth character in the character string to be printed are set to the size of the fourth character defined in the definition table Tbl1, that is, the size of the character at IDX “4”. The sizes of the seventh character and the eighth character in the character string to be printed are set to the size of the fifth character defined in the definition table Tbl1, that is, the size of the character at IDX “5”. The size of the character that corresponds to the tape width Wt0 is set. By setting the sizes of the respective characters in this manner and executing printing in the “stepwise reduction mode”, a print result illustrated in Example 3 of FIG. 3 is obtained.

In Example 6 of FIG. 4, seven characters are printed. As mentioned above, when a character string of four to eight characters is printed in the “stepwise enlargement mode”, the definition table Tbl2 illustrated in FIG. 6 is used. In this case, the number of characters to be printed is two more than the number of characters that the definition table Tbl2 corresponds to.

Therefore, Rule 2 is applied in which the size of some characters in the character string is set to the size of the character that is set for an adjacent character. A value obtained by doubling a difference D2 between the number of characters to be printed and the number of characters that the definition table Tbl2 corresponds to is referred to as an applicable character count N2. Characters to which Rule 2 is applied are the characters equal in number to the applicable character count N2, counted from the first character of the character string to be printed. In Example 6 of FIG. 4, since the difference D2 between the number of characters to be printed and the number of characters that the definition table Tbl2 corresponds to is two, the applicable character count N2 is four. Accordingly, four characters, counted from the first character of the character string, are subject to the application of Rule 2.

The sizes of the first character and the second character in the character string to be printed are set to the size of the first character defined in the definition table Tbl2, that is, the size of the character at IDX “1”. The sizes of the third character and the fourth character in the character string to be printed are set to the size of the second character defined in the definition table Tbl2, that is, the size of the character at IDX “2”. The size of the character that corresponds to the tape width Wt0 is set. By setting the sizes of the respective characters in this manner and executing printing in the “stepwise enlargement mode”, a print result illustrated in Example 6 of FIG. 4 is obtained.

In Example 7 of FIG. 4, eight characters are printed. Here, spaces are not included in the number of characters. The number of characters to be printed is three more than the number of characters that the definition table Tbl2 corresponds to. In Example 7 of FIG. 4, since the difference D2 between the number of characters to be printed and the number of characters that the definition table Tbl2 corresponds to is three, the applicable character count N2 is six. Accordingly, six characters, counted from the first character of the character string, are subject to the application of Rule 2.

The sizes of the first character and the second character in the character string to be printed are set to the size of the first character defined in the definition table Tbl2, that is, the size of the character at IDX “1”. The sizes of the third character and the fourth character in the character string to be printed are set to the size of the second character defined in the definition table Tbl2, that is, the size of the character at IDX “2”. The sizes of the fifth character and the sixth character in the character string to be printed are set to the size of the third character defined in the definition table Tbl2, that is, the size of the character at IDX “3”. The size of the character that corresponds to the tape width Wt0 is set. By setting the sizes of the respective characters in this manner and executing printing in the “stepwise enlargement mode”, a print result illustrated in Example 7 of FIG. 4 is obtained.

The number of characters to be printed may be less than the number of characters that the definition table corresponds to. For example, the definition table Tbl1 may be used to print a four-character character string. In this case, only a part of the information defined in the definition table Tbl1 is used. Specifically, when printing is executed in the “stepwise enlargement mode”, the sizes of the second to fifth characters defined in the definition table Tbl1, that is, the sizes of the characters at IDX “2” to IDX “5”, are set for the respective characters that constitute the character string to be printed. Consequently, the vertical dimension of the largest character to be printed does not become extremely small relative to the tape width Wt0. In addition, when printing is executed in the “stepwise reduction mode”, the sizes of the first character to the fourth character defined in the definition table Tbl1, that is, the sizes of the characters at IDX “1” to IDX “4” are set for the respective characters that constitute the character string to be printed. As a result, the vertical dimension of the largest character to be printed does not become extremely small relative to the tape width Wt0.

As mentioned above, by sharing a single definition table when printing different numbers of characters without individually preparing definition tables according to the number of characters to be printed, it is possible to reduce the effort required to create the definition tables and to reduce the capacity used in the storage portion 190.

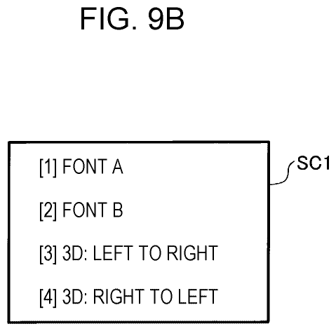

FIG. 9A is a flowchart illustrating a printing process in the tape printing device 100. FIG. 9B is an explanatory diagram illustrating an example of a selection screen to be described below. Before the processing illustrated in FIG. 9A is started, the tape cartridge TPC is attached to the tape printing device 100.

In step S101, the tape width Wt0, which is the width of the tape TP of the tape cartridge TPC attached to the tape printing device 100, is detected. Specifically, a protrusion and recess pattern formed on a bottom surface of the tape cartridge TPC is read by the width detection portion 110 and transmitted to the controller 180. The protrusion and recess pattern formed on the bottom surface of the tape cartridge TPC indicates the tape width Wt0 of the tape TP stored in the tape cartridge TPC.

In step S103, the controller 180 acquires the print width Wtp of the tape TP attached to the tape printing device 100 by referring to the print width information set Itw in the storage portion 190 based on the detected tape width Wt0.

In step S105, the controller 180 receives input from the user. The user inputs a character string to be printed via the input portion 120.

In step S107, the controller 180 receives designation of a font to be printed from the user. The user can designate a printing mode by performing the following operations. For example, the user operates the input portion 120 to input a predetermined key. In response to this operation, the controller 180 displays a selection screen SC1 for selecting a font to be printed as illustrated in FIG. 9B on the display portion 130. In the selection screen SC1, for example, a plurality of font-related options are displayed as follows. The user can select a desired option on the selection screen SC1.
[1] Font A
[2] Font B
[3] 3D: Left to right
[4] 3D: Right to left

When “Font A” and “Font B” are selected on the selection screen SC1 illustrated in FIG. 9B, the input character string is subsequently printed in the selected font in step S115. In this case, printing in which the sizes of the characters are stepwise changed is not executed. When “3D: Left to right” is selected, the input character string is subsequently printed in the “stepwise enlargement mode” in step S115. When “3D: Right to left” is selected, the input character string is subsequently printed in the “stepwise reduction mode”in step S115.

In step S109 illustrated in FIG. 9A, the controller 180 determines whether or not the input instruction from the user is an instruction for the perspective transformation printing. When “3D: Left to right” or “3D: Right to left” is selected in the above-described font selection, the controller 180 determines to execute perspective transformation printing.

When an instruction to execute the perspective transformation printing is issued (step S109; YES), the controller 180 executes the processing of step S111. When no instruction to execute the perspective transformation printing is issued (step S109; NO), the controller 180 executes the processing of step S113.

In step S111, the controller 180 determines the sizes of the respective characters included in the input character string by referring to the definition table included in the character size definition table set Itb based on the tape width Wt0.

In step S113, the controller 180 generates print data. When the perspective transformation printing is executed, the print data is generated based on the size of each character determined in step S111 and the printing condition designated by the user. The print data for perspective transformation printing, that is, for printing in which the sizes of the respective characters included in the character string are stepwise changed to print the character string, is also referred to as “specific print data”. Additionally, for example, the size of the character when perspective transformation printing is not executed is set, for example, to a size set in advance according to the print width Wtp. The controller 180 outputs the generated print data to the printing portion 160.

In step S115, the printing portion 160 executes printing on the tape TP based on the supplied print data.

As described above, the tape printing device 100 according to the present embodiment prints a character string in an aspect having a sense of perspective by performing printing while stepwise changing the sizes of the respective characters included in the character string. The tape printing device 100 determines the sizes of the respective characters included in the character string based on the definition table corresponding to the number of characters in the character string and the width of the tape-like printing medium. Therefore, the processing load on the tape printing device 100 when printing a character string having a sense of perspective can be reduced as compared with an aspect in which the size of each character is calculated using a mathematical expression. Accordingly, the effort required for label creation can be simplified.

### B. Second Embodiment

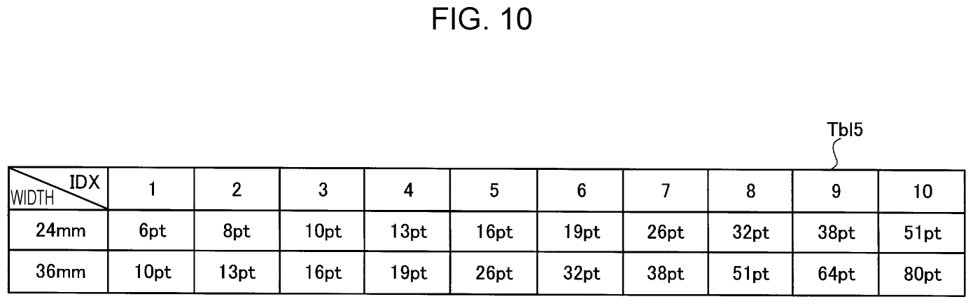

FIG. 10 is an explanatory diagram illustrating an example of a definition table included in the character size definition table set Itb. The following description focuses on configurations that differ from the configurations of the first embodiment, and configurations similar to the configurations of the first embodiment will not be described. In the first embodiment, as illustrated in FIGS. 7 and 8, when the character string to be printed has a certain length, the same size may be set for two adjacent characters in order to make the stepwise change in character size more gradual. A definition table Tbl5 illustrated in FIG. 10 is used when a 10-character character string is printed in the “stepwise enlargement mode”. In the definition table Tbl5, the sizes of the characters when the tapes TP having tape widths Wt0 of 24 mm and 36 mm are used are defined. Unlike the definition table Tbl3 illustrated in FIG. 7, different sizes are set for two adjacent characters in the definition table Tbl5. The definition table using a 10-character character string in the “stepwise reduction mode”will not be illustrated.

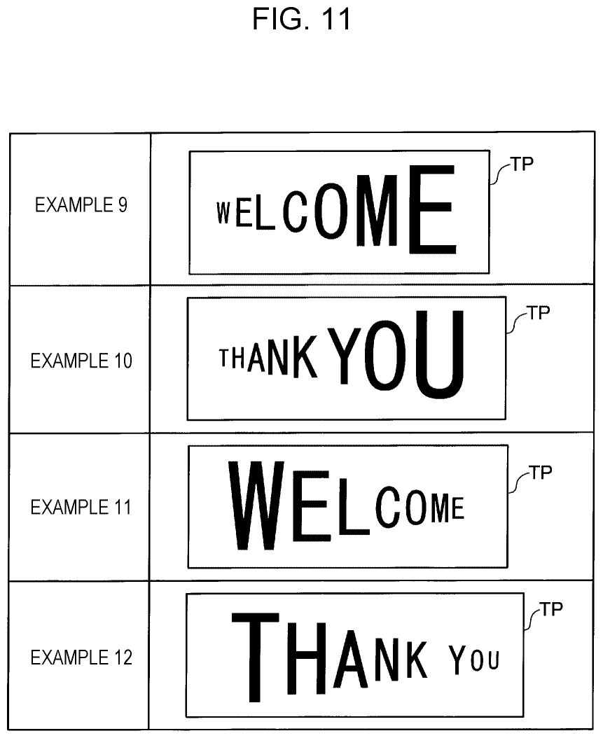

FIG. 11 is an explanatory diagram illustrating an example of a print result of the perspective transformation printing. Examples 9 and 10 of FIG. 11 illustrate print results in the “stepwise enlargement mode” using the definition table Tbl5. In the present embodiment, the definition table Tbl5 is used when a character string of 10 or fewer characters is printed in the “stepwise enlargement mode”. Since the number of characters to be printed in Examples 9 and 10 illustrated in FIG. 11 is less than the number of characters that the definition table Tbl5 corresponds to, only a part of the information defined in the definition table Tbl5 is used.

For example, the sizes of the fourth character to the tenth character defined in the definition table Tbl5, that is, the sizes of the characters at IDX “4” to IDX “10” are set for the respective characters that constitute the character string illustrated in Example 9 of FIG. 11. The sizes of the third character to the tenth character defined in the definition table Tbl5, that is, the sizes of the characters at IDX “3” to IDX “10” are set for the respective characters that constitute the character string illustrated in Example 10 of FIG. 11.

Examples 11 and 12 of FIG. 11 illustrate print results in the “stepwise reduction mode”. Examples 11 and 12 of FIG. 11 illustrate the print results printed using a definition table (not illustrated) for the “stepwise reduction mode” in which two adjacent characters are set to different sizes, similarly to the definition table Tbl5. In the present embodiment, the stepwise change in character size can be made steeper as compared with the first embodiment. As a result, a print result that gives a greater sense of depth can be obtained as compared with the print results of the first embodiment illustrated in FIGS. 3 and 4.

### C. Third Embodiment

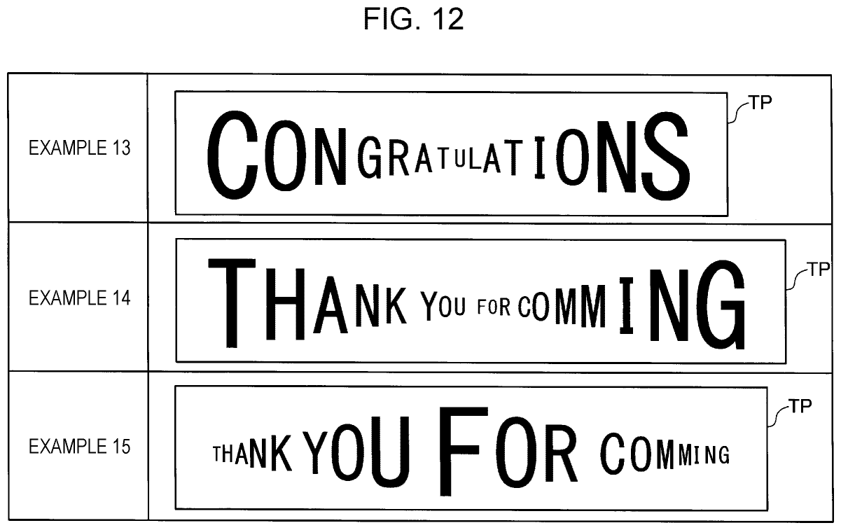

FIG. 12 is an explanatory diagram illustrating an example of a print result of the perspective transformation printing. The following description focuses on configurations that differ from the configurations of the first embodiment, and configurations similar to the configurations of the first embodiment will not be described.

In print results illustrated in Examples 13 and 14 of FIG. 12, a character string that gives a sense of depth is represented in which the first and last characters of the character string are disposed at the foremost, and the middle character of the character string is disposed at the rearmost.

In Examples 13 and 14, when the character string is divided into two portions, an aspect of change in sizes of characters included in a first half portion is different from an aspect of change in sizes of characters included in a second half portion. The second half portion is a portion of the character string excluding the first half portion. More specifically, in the print results illustrated in Examples 13 and 14, the characters are represented in an aspect in which the sizes of the characters gradually decrease along the arrangement direction of characters from the first character of the character string to the middle character of the character string, and the characters are represented in an aspect in which the sizes of the characters gradually increase along the arrangement direction of characters from the middle character of the character string to the last character of the character string. This perspective transformation printing method of performing printing in this manner is referred to as a “composite first mode”. Through printing in the “composite first mode”, a print result can be obtained as though a vanishing point in perspective is set at the center of the tape TP. Printing in the “composite first mode” is also referred to as “third perspective transformation printing”.

In a print result illustrated in Example 15 of FIG. 12, a character string that gives a sense of depth is represented in which the middle character of the character string is disposed at the foremost and the first and last characters of the character string are disposed at the rearmost.

In Example 15 of FIG. 12, when the character string is divided into two portions, an aspect of change in the sizes of the characters included in the first half portion is different from an aspect of change in the sizes of the characters included in the second half portion. The second half portion is a portion of the character string excluding the first half portion. More specifically, in the print result illustrated in Example 15, the characters are represented in an aspect in which the sizes of the characters are gradually changed to larger sizes along the arrangement direction of characters from the first character of the character string to the middle character of the character string, and the characters are represented in an aspect in which the sizes of the characters are gradually changed to smaller sizes along the arrangement direction of characters from the middle character of the character string to the last character of the character string. This perspective transformation printing method of performing printing in this manner is referred to as a “composite second mode”. Through printing in the “composite second mode”, a print result can be obtained as though a vanishing point in perspective is set at both ends of the tape TP in the longitudinal direction. Printing in the “composite second mode” is also referred to as “fourth perspective transformation printing”.

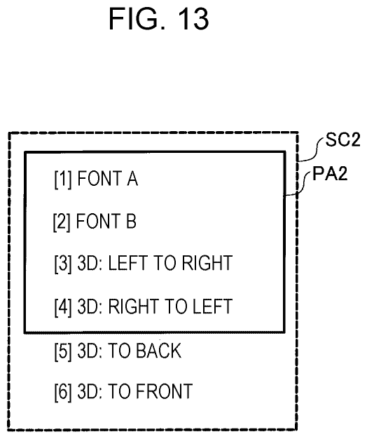

FIG. 13 is an explanatory diagram illustrating another example of the selection screen. In the present embodiment, in step S107 illustrated in FIG. 9A, when receiving designation of the font to be printed from the user, the controller 180 can display, on a selection screen SC2 for selecting a font option to be printed as illustrated in FIG. 13, for example, the following font options. The user can select a desired option on the selection screen.
[1] Font A
[2] Font B
[3] 3D: Left to right
[4] 3D: Right to left
[5] 3D: To the back
[6] 3D: To the front

A partial region PA2, which is a part of the selection screen SC2, is displayed on the display portion 130. This is because the vertical size of the display region of the display portion 130 is limited. The user can check a desired range of the selection screen SC2 by scrolling the selection screen SC2 through an operation of the input portion 120.

When “3D: To the back” is selected on the selection screen SC2 as illustrated in FIG. 13, the input character string is printed in the “composite first mode”. When “3D: To the front” is selected, the input character string is printed in the “composite second mode”.

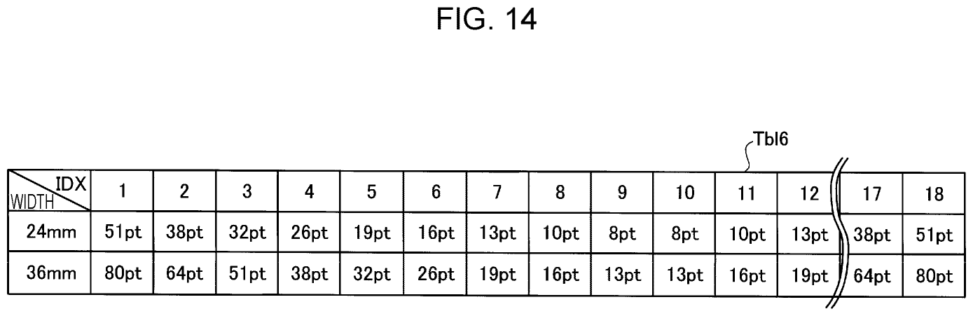

FIG. 14 is an explanatory diagram of a definition table Tbl6 used when printing is performed in the composite first mode. In the definition table Tbl6, the sizes of the characters when the tapes TP having tape widths Wt0 of 24 mm and 36 mm are used are defined. When printing is performed in the “composite first mode”, the controller 180 determines the sizes of the respective characters included in the input character string by referring to the definition table included in the character size definition table set Itb based on the tape width Wt0. When Example 13 is printed, since the number of characters to be printed is less than the number of characters that the definition table Tbl6 corresponds to, only a part of the information defined in the definition table Tbl6 is used. Specifically, when the characters are set, at least the character having the smallest character size defined in the definition table Tbl6 is excluded. When the characters are set, in addition to the smallest character, one or more characters consecutive to the smallest character defined in the definition table Tbl6 can also be excluded according to the difference between the number of characters to be printed and the number of characters that the definition table Tbl6 corresponds to. For example, information excluding information on the sizes of the ninth to eleventh characters, that is, excluding information on the sizes of the characters at IDX “9” to IDX “11”, is used.

Although the definition table used when printing is performed in the composite second mode is not illustrated, in the definition table used when printing is performed in the composite second mode, the sizes of the characters are set to gradually increase along the arrangement direction of characters from the first character of the character string to the middle character of the character string, and the sizes of the characters are set to gradually decrease along the arrangement direction of characters from the middle character of the character string to the last character of the character string. In the present embodiment, as compared with the first embodiment, a broader range of printing aspects having a sense of perspective can be selected by the user.

### D. Other Embodiments

D1. As illustrated in Example 3 of FIG. 3 and Example 7 of FIG. 4, the character string to be printed may include a space as a delimiter character. In this case, the controller 180 may set the size of the space to a size set for another character disposed immediately after the space, which is a delimiter character, in the arrangement direction of characters. This is to improve the appearance of the character string to be printed. The space and the other character disposed immediately after the space are consecutive, and no other character exists between the space and the other character. In addition, the same applies when an interpunct or a hyphen is included as a delimiter character in the character string to be printed. A space, an interpunct, and a hyphen as delimiter characters are also referred to as a “second delimiter character”.

A comma may be included as a delimiter character in the character string to be printed. In this case, the controller 180 may set the size of the comma to a size set for another character disposed immediately before the comma, which is a delimiter character, in the arrangement direction of characters. This is to improve the appearance of the character string to be printed. The comma and the other character disposed immediately before the comma are consecutive, and no other character exists between the comma and the other character. The same applies when a punctuation mark, a question mark (?), and an exclamation mark (!) are included as delimiter characters in the character string to be printed. The punctuation mark, the comma, the question mark (?), and the exclamation mark (!) as delimiter characters are also referred to as a “first delimiter character”.
D2. The user may be able to designate the aspect of change in the sizes of the characters in units of partial character strings delimited by delimiter characters of the character string. Here, a delimiter character that is disposed at the beginning or end of the character string to be printed is excluded from the delimiter characters that delimit the character string. For example, when printing a character string as illustrated in Example 3 of FIG. 3, the user can designate, for each of a portion before the space, which serves as the delimiter character, and a portion after the space, whether to perform printing in any one of the “stepwise enlargement mode”, the “stepwise reduction mode”, the “composite first mode”, or the “composite second mode”. The tape printing device 100 executes printing according to the designated content.
D3. The user may be able to designate a position at which the character string is to be delimited, and to designate the aspect of change in the sizes of the characters in units of partial character strings delimited at a designated position. The user can designate, for each of a first half portion and a second half portion of the character string delimited at the designated position, whether to perform printing in any one of the “stepwise enlargement mode”, the “stepwise reduction mode”, the “composite first mode”, or the “composite second mode”. The tape printing device 100 executes printing according to the designated content.
D4. In the first embodiment, an example of horizontal printing is described, but the tape printing device 100 may perform vertical printing. In vertical printing, characters are disposed such that the feed direction Dlt of the tape TP is parallel to the direction Drc in which characters are to be read. The direction Drc in which the characters are to be read is a direction intersecting the width direction of the tape TP, which is the printing medium. The feed direction of the tape TP during printing is parallel to the longitudinal direction of the tape TP. In vertical printing, when the user visually recognizes a state in which the tape TP is disposed such that the longitudinal direction of the tape TP is positioned vertically, characters are printed in vertical writing on the tape TP.
D5. In the examples illustrated in FIGS. 3, 4, and the like, the characters are aligned to the center in the width direction of the tape TP. However, the tape printing device 100 may execute printing with character alignment set to top alignment or bottom alignment in the width direction of the tape TP according to the designation of the user. Setting the character alignment to top alignment refers to aligning an upper end portion of each character with an upper end of the printable region indicated by the print width Wtp. Setting the character alignment to bottom alignment refers to aligning a lower end portion of each character with a lower end of the printable region indicated by the print width Wtp.
D6. In the above-described embodiment, an example is described in which the controller 180 of the tape printing device 100 executes the processing of steps S105 to S115 illustrated in FIG. 9A. The processing of steps S105 to S115 illustrated in FIG. 9A may be executed by another device that communicates with the tape printing device 100. The other device is a device that can communicate with the tape printing device 100 via wireless or wired connection, such as a smartphone, a tablet, or a personal computer.
D7. In the first embodiment, an example is described in which, when a character string having a greater number of characters than the number of characters that the definition table corresponds to is printed in the “stepwise reduction mode”, the same size is set for adjacent characters among consecutive characters including a predetermined number of characters from the last character of the character string in a direction opposite to the arrangement direction of characters. Alternatively, when a character string having a greater number of characters than the number of characters that the definition table corresponds to is printed in the “stepwise reduction mode”, the same size may be set for adjacent characters among consecutive characters including a predetermined number of characters from the first character of the character string in the arrangement direction of characters.

In the first embodiment, an example is described in which, when a character string having a greater number of characters than the number of characters that the definition table corresponds to is printed in the “stepwise enlargement mode”, the same size is set for adjacent characters among consecutive characters including a predetermined number of characters from the first character of the character string in the arrangement direction of characters. Alternatively, when a character string having a greater number of characters than the number of characters that the definition table corresponds to is printed in the “stepwise enlargement mode”, the same size may be set for adjacent characters among consecutive characters including a predetermined number of characters from the last character of the character string in a direction opposite to the arrangement direction of characters.

When a character string having a greater number of characters than the number of characters that the definition table corresponds to is printed in the “stepwise reduction mode”, the same size may be set for consecutive characters including a predetermined number of characters from the first character of the character string in the arrangement direction of characters. Further, the same size may be set for consecutive characters including a predetermined number of characters from the end of the character string in a direction opposite to the arrangement direction of characters. The same applies when a character string having a greater number of characters than the number of characters that the definition table corresponds to is printed in the “stepwise enlargement mode”.
D8. In the embodiment, an example is described in which the input portion 120 is a keyboard, but the input portion 120 may include a touch panel or a combination of a microphone and voice recognition software.

In the embodiment, an example is described in which the display portion 130 is a liquid crystal display, but the display portion 130 may include an organic EL display or an electronic paper. Further, the method by which the width detection portion 110 detects the tape width Wt0 is not limited to the method described in the above-described embodiment, and any detection method can be employed.

### E. Other Embodiments

The present disclosure is not limited to the embodiment mentioned above and can be implemented in various embodiments without departing from the gist of the present disclosure. For example, the present disclosure can also be implemented in the following embodiments. The technical features in the above-described embodiment that correspond to the technical features in each of the embodiments described below can be replaced or combined as appropriate in order to solve a part or all of the problems of the present disclosure or to achieve a part or all of the effects of the present disclosure. Additionally, unless the technical feature is described as essential in the present specification, the technical feature can be deleted as appropriate.
1. According to a first aspect of the present disclosure, there is provided a tape printing device that performs printing on a tape-like printing medium. The tape printing device includes an input portion that receives input of a character string and designation of a printing condition, a controller that controls the tape printing device, a storage portion that stores at least one definition table used when particular printing is executed in which sizes of respective characters included in the character string are stepwise changed to print the character string, the definition table defining the sizes of the respective characters included in the character string in correspondence with the number of characters in the character string and a width of the printing medium, and a printing portion that prints the input character string on the printing medium. The controller, when the printing condition designates the particular printing, sets the sizes for the respective characters included in the character string based on the definition table corresponding to the number of characters and the width, and generates specific print data indicating that each character is to be printed in the size set for the character. The printing portion prints the character string on the printing medium based on the specific print data.

According to the above-described aspect, the character string is printed in an aspect having a sense of perspective by performing printing while stepwise changing the sizes of the respective characters included in the character string. The sizes of the respective characters included in the character string are determined based on the definition table corresponding to the number of characters in the character string and the width of the tape-like printing medium. Therefore, the processing load on the tape printing device when printing a character string having a sense of perspective can be reduced as compared with an aspect in which the size of each character is calculated using a mathematical expression. Accordingly, the effort required for label creation can be simplified.
2. In the tape printing device of the above-described aspect, a display portion that displays information is further provided. The controller may cause the display portion to display a plurality of options representing the printing condition, and receive, as the designation of the printing condition, selection of the option indicating the particular printing.
3. In the tape printing device of the above-described aspect, the particular printing may include first perspective transformation printing and second perspective transformation printing, the first perspective transformation printing may print the character string in an aspect in which the sizes of the respective characters included in the character string are stepwise changed to larger sizes along an arrangement direction of the characters in the character string, and the second perspective transformation printing may print the character string in an aspect in which the sizes of the respective characters included in the character string are stepwise changed to smaller sizes along the arrangement direction.

According to the above-described aspect, the user can select a desired one from among a plurality of options having different forms as the aspect having a sense of perspective.
4. In the tape printing device of the above-described aspect, the particular printing may further include third perspective transformation printing. In the third perspective transformation printing, printing may be performed in an aspect in which sizes of respective characters included in a first half portion obtained by dividing the character string into two portions are stepwise changed to smaller sizes along the arrangement direction, and printing may be performed in an aspect in which sizes of respective characters included in a second half portion obtained by dividing the character string into two portions are stepwise changed to larger sizes along the arrangement direction.
5. In the tape printing device of the above-described aspect, the particular printing may further include fourth perspective transformation printing, and in the fourth perspective transformation printing, printing may be performed in an aspect in which the sizes of the respective characters included in the first half portion obtained by dividing the character string into two portions are stepwise changed to larger sizes along the arrangement direction, and printing may be performed in an aspect in which the sizes of the respective characters included in the second half portion obtained by dividing the character string into two portions are stepwise changed to smaller sizes along the arrangement direction.
6. In the tape printing device of the above-described aspect, the definition table may be associated with a predetermined width of the printing medium, with the number of characters being N, where N is an integer equal to or greater than 3, the definition table defining sizes of respective N characters included in the character string, when the number of characters is within a range from N to M, where M is an integer greater than N and a difference between M and N is within a certain range, the definition table may be used to set the sizes of the respective characters included in the character string, and the definition table may be uniquely determined according to the number of characters and the width. The controller, when the number of characters is M, may set sizes of two or more consecutive characters among the characters included in the character string to the same size in accordance with the definition table and a predetermined procedure.

However, it is not practical to individually prepare definition tables according to the number of characters to be printed, from the viewpoint of the effort required to create the definition tables and the capacity occupied by the definition tables in the storage portion. Therefore, in the above-described embodiment, the same definition table can be used not only when the number of characters is M but also when the number of characters is N. Accordingly, as compared with an aspect in which definition tables are prepared individually according to the number of characters to be printed, it is possible to reduce the effort required to create definition tables and to reduce the capacity used in the storage portion.
7. In the tape printing device of the above-described aspect, the controller, when a predetermined first delimiter character is included in the character string to be printed, may set a size of the first delimiter character to a size set for another character that is disposed immediately before the first delimiter character in the arrangement direction, and when a second delimiter character different from the first delimiter character is included in the character string to be printed, may set a size of the second delimiter character to a size set for another character that is disposed immediately after the second delimiter character in the arrangement direction.
8. In the tape printing device of the above-described aspect, the first delimiter character may include a punctuation mark, and the second delimiter character may include an interpunct.
9. According to a second aspect of the present disclosure, there is provided a printing method executed by a tape printing device that performs printing on a tape-like printing medium. The printing method includes receiving input of a character string and designation of a printing condition, executing printing on the printing medium, and when the designation of the printing condition designates particular printing in which sizes of respective characters included in the character string are stepwise changed to print the character string, setting the sizes for the respective characters included in the character string based on at least one definition table corresponding to the number of characters in the character string and a width of the printing medium, the definition table defining the sizes of the respective characters included in the character string, generating specific print data indicating that each character is to be printed in the size set for the character, and printing the character string on the printing medium based on the specific print data.

According to the above-described aspect, the sizes for the respective characters included in the character string are determined by referring to the definition table corresponding to the number of characters in the character string and the width of the tape-like printing medium. Therefore, the processing load on the tape printing device when printing a character string having a sense of perspective can be reduced as compared with an aspect in which the size of each character is calculated using a mathematical expression. Accordingly, the effort required for label creation can be simplified.
10. According to a third aspect of the present disclosure, there is provided a non-transitory computer-readable storage medium storing a program for causing a tape printing device that performs printing on a tape-like printing medium to execute printing. The program causes the tape printing device to implement a function of receiving input of a character string and designation of a printing condition, and a function of executing printing on the printing medium. The function of executing printing on the printing medium includes, when the designation of the printing condition designates particular printing in which sizes of respective characters included in the character string are stepwise changed to print the character string, a function of setting the sizes for the respective characters included in the character string based on at least one definition table corresponding to the number of characters in the character string and a width of the printing medium, the definition table defining the sizes of the respective characters included in the character string, a function of generating specific print data indicating that each character is to be printed in the size set for the character, and a function of printing the character string on the printing medium based on the specific print data.

According to the above-described aspect, the sizes for the respective characters included in the character string are determined by referring to the definition table corresponding to the number of characters in the character string and the width of the tape-like printing medium. Therefore, the processing load on the tape printing device when printing a character string having a sense of perspective can be reduced as compared with an aspect in which the size of each character is calculated using a mathematical expression. Accordingly, the effort required for label creation can be simplified.

What is claimed is:

1. A tape printing device that executes printing on a tape-like printing medium, the tape printing device comprising:
an input portion that receives input of a character string and designation of a printing condition;
a controller that controls the tape printing device;
a storage portion that stores at least one definition table used when particular printing is executed in which sizes of respective characters included in the character string are stepwise changed to print the character string, the definition table defining the sizes of the respective characters included in the character string in correspondence with the number of characters in the character string and a width of the printing medium; and
a printing portion that executes printing on the printing medium, wherein
the controller
when the printing condition designates the particular printing,
sets the sizes for the respective characters included in the character string based on the definition table corresponding to the number of characters and the width, and
generates specific print data indicating that each character is to be printed in the size set for the character, and
the printing portion prints the character string on the printing medium based on the specific print data.

2. The tape printing device according to claim 1, further comprising:
a display portion that displays information, wherein
the controller
causes the display portion to display a plurality of options representing the printing condition, and
receives, as the designation of the printing condition, selection of the option indicating the particular printing.

3. The tape printing device according to claim 2, wherein
the particular printing includes first perspective transformation printing and second perspective transformation printing,
the first perspective transformation printing prints the character string in an aspect in which the sizes of the respective characters included in the character string are stepwise changed to larger sizes along an arrangement direction of the characters in the character string, and
the second perspective transformation printing prints the character string in an aspect in which the sizes of the respective characters included in the character string are stepwise changed to smaller sizes along the arrangement direction.

4. The tape printing device according to claim 3, wherein
the particular printing further includes third perspective transformation printing, and
in the third perspective transformation printing,
printing is performed in an aspect in which sizes of respective characters included in a first half portion obtained by dividing the character string into two portions are stepwise changed to smaller sizes along the arrangement direction, and
printing is performed in an aspect in which sizes of respective characters included in a second half portion obtained by dividing the character string into two portions are stepwise changed to larger sizes along the arrangement direction.

5. The tape printing device according to claim 4, wherein
the particular printing further includes fourth perspective transformation printing, and
in the fourth perspective transformation printing,
printing is performed in an aspect in which the sizes of the respective characters included in the first half portion obtained by dividing the character string into two portions are stepwise changed to larger sizes along the arrangement direction, and
printing is performed in an aspect in which the sizes of the respective characters included in the second half portion obtained by dividing the character string into two portions are stepwise changed to smaller sizes along the arrangement direction.

6. The tape printing device according to claim 5, wherein
the definition table is associated with a predetermined width of the printing medium, with the number of characters being N, where N is an integer equal to or greater than 3, the definition table defining sizes of respective N characters included in the character string,
when the number of characters is within a range from N to M, where M is an integer greater than N and a difference between M and N is within a certain range, the definition table is used to set the sizes of the respective characters included in the character string,
the definition table is uniquely determined according to the number of characters and the width, and
the controller, when the number of characters is M, sets sizes of two or more consecutive characters among the characters included in the character string to the same size in accordance with the definition table and a predetermined procedure.

7. The tape printing device according to claim 1, wherein
the controller
when a predetermined first delimiter character is included in the character string to be printed, sets a size of the first delimiter character to a size set for another character that is disposed immediately before the first delimiter character in the arrangement direction, and
when a second delimiter character different from the first delimiter character is included in the character string to be printed, sets a size of the second delimiter character to a size set for another character that is disposed immediately after the second delimiter character in the arrangement direction.

8. The tape printing device according to claim 7, wherein
the first delimiter character includes a punctuation mark, and
the second delimiter character includes an interpunct.

9. A printing method executed by a tape printing device that performs printing on a tape-like printing medium, the printing method comprising:
receiving input of a character string and designation of a printing condition;
executing printing on the printing medium; and
when the designation of the printing condition designates particular printing in which sizes of respective characters included in the character string are stepwise changed to print the character string,
setting the sizes for the respective characters included in the character string based on at least one definition table corresponding to the number of characters in the character string and a width of the printing medium, the definition table defining the sizes of the respective characters included in the character string;
generating specific print data indicating that each character is to be printed in the size set for the character; and
printing the character string on the printing medium based on the specific print data.

10. A non-transitory computer-readable storage medium storing a program for causing a tape printing device that performs printing on a tape-like printing medium to execute printing, the program causing the tape printing device to implement:
a function of receiving input of a character string and designation of a printing condition; and
a function of executing printing on the printing medium, wherein
the function of executing printing on the printing medium includes
when the designation of the printing condition designates particular printing in which sizes of respective characters included in the character string are stepwise changed to print the character string,
a function of setting the sizes for the respective characters included in the character string based on at least one definition table corresponding to the number of characters in the character string and a width of the printing medium, the definition table defining the sizes of the respective characters included in the character string,
a function of generating specific print data indicating that each character is to be printed in the size set for the character, and
a function of printing the character string on the printing medium based on the specific print data.
